(19) United States
(12) Patent Application Publication
(10) Pub. No.: US 2008/0017118 A1
(43) Pub. Date: Jan. 24, 2008

(54) Device and Method for Automatic Milking of Animals

(75) Inventors: Bengt-Ove Wigholm, Toreboda (SE); Mats Fellbrandt, Tibro (SE)

Correspondence Address: HOVEY WILLIAMS LLP, 2405 GRAND BLVD., SUITE 400, KANSAS CITY, MO, 64108, US

(73) Assignee: DELAVAL HOLDING AB, Tumba (SE)

(21) Appl. No.: 11/576,110

(22) PCT Filed: Aug. 1, 2005
(86) PCT No.: PCT/SE05/01192

§ 371 Date: Aug. 13, 2007

(30) Foreign Application Priority Data
Oct. 1, 2004 (SE) 0402381-8

(51) Int. Cl. A01K 1/12; A01J 5/017

(52) U.S. Cl. 119/14.03

(57) ABSTRACT

A milking arrangement (1) for automatic milking of animals (9) is described. The milking arrangement includes a feeding area (4) arranged for supplying food to the animals (9), a resting area (2) arranged for allowing the animals (9) to rest, and a milking area (3) with at least one milking station (16, 17) for milking the animals. The milking arrangement also includes a oneway gate (12) arranged between the resting area (2) and the feeding area (4) allowing access from the resting area (2) to the feeding area (4) and at least a first access device (14) arranged between the feeding area (4) and the milking area (3) allowing access between the feeding area (4) and the milking area (3) only in the direction from the feeding area (4) to the milking area (3). A method for managing animals within a milking arrangement is also described.

### TECHNICAL FIELD

The invention relates to an arrangement for voluntary automatic milking of animals as defined in the introductory part of the independent claim directed to a milking arrangement. The invention also relates to a method for use in such arrangements according to the preamble of the independent method claim.

### DESCRIPTION OF THE PRIOR ART

Arrangements for voluntary automatic milking of animals have been used for some years. Such arrangements usually comprise a stall, a resting area, a feeding area, and a milking area comprising at least one milking robot for applying teat cups to the animals. In such arrangements the animals may be free to move around between the resting area, the feeding area, and the milking area. Such arrangements may be arranged for the animals to voluntarily attend to the milking robot when the animals desire to be milked.

A problem with such a voluntary milking system where the animals are free to move between the milking area, the feeding area and the resting area is that they move between these areas in a way that is far from optimum, with regard to the milk production.

In the international application WO 96/03031 a device and method for automatically milking of animals is disclosed. In the device disclosed in WO 96/03031 the animals are guided from a resting and walking area via an access sluice either to a milking stall or to a feeding and watering space dependent on whether the animal is allowed to be milked or not. After milking the animals may enter the feeding and watering space, and after feeding the animals may return to the resting and walking area via a one-directional gate. As the animals have to attend to the sluice in order to get to the feeding and watering space, the animals are stimulated to attend to the milking stall in a device according to WO 96/03031.

However, it is believed that animals do not always attend to the sluice as often as would be optimum for the milk production. In such an arrangement as shown in said international application some animals rest longer than optimum before attempting to move to the feeding and watering space.

### DESCRIPTION OF THE INVENTION

An object of the present invention is to provide a milking arrangement and a method for automatic milking, which is arranged in such a way that a high milk production from the animals is achieved.

Another object of the present invention is to provide a milking arrangement with a milking station for automatic milking, which is arranged in such a way that the animals attend frequently and voluntarily to the milking station.

A milking arrangement according to the present invention for automatic milking of animals, comprises a feeding area arranged for supplying food to the animals, a resting area arranged for allowing the animals to rest, and a milking area with at least one milking station provided with means for attachment of teat cups, milking and detachment of the teat cups. The milking arrangement is characterized in that it comprises a oneway gate arranged between the resting area and the feeding area allowing access from the resting area to the feeding area and at least a first access device arranged between the feeding area and the milking area allowing access between the feeding area and the milking area only in the direction from the feeding area to the milking area.

In a milking arrangement according to the present invention water may be provided to the animals in the feeding area as well as in the resting area.

With a milking arrangement according to the present invention it has been found that the animals are milked more often than in milking arrangements according to the prior art. The milking area may be arranged in a number of different ways. The milking stations within the milking arrangement may be arranged in a so called rotary or in a stationary arrangement.

In a milking arrangement according to the present invention the first access device may be arranged to allow an animal to pass from the feeding area to one of at least the milking area and the resting area. It is of course also possible to let all animals that attend to the first access device pass to the milking area. However, it is favorable to make a selection of the animals before allowing them into the milking area. Animals that have been milked recently should for example not be allowed to enter the milking area, to achieve an efficient milk production in the milking arrangement.

The milking arrangement may comprise at least a first animal identification means being arranged to identify an animal attending the first access device, and first control means for the control of the first access device dependent on the identity of the animal and whether the animal is permitted to be milked or not. By having a first animal identification means and first control means it is possible to identify each animal attending the first access device and to control the access device dependent on the identity of the animal. In this way one may select only animals that have not been milked for a predetermined time and that are not sick, to be allowed to enter the milking area in order to be milked.

The milking arrangement may comprise directing means in the milking area directing an animal that has passed through the first access device into the milking area to enter a milking station in which the animal is milked before the animal is allowed to leave the milking area. The directing means may be a mechanical gate that directs the animals into a milking station. This is an alternative to allowing the animals themselves make the decision, whether they wish to enter a milking station or not.

Regardless of whether the milking arrangement comprises directing means in the milking area or not, the milking stations may be arranged for providing concentrated food to the animals when they are milked. The concentrated food makes the animals calm during milking. In case no directing means are provided the concentrated food may also be used to tempt the animals to enter a milking station.

The milking arrangement may comprise a second access device provided between the milking area and the resting area, allowing access between the milking area and the resting area only in the direction from the milking area to the resting area. By providing such an access device animals are hindered from entering the milking area directly from the resting area.

The second access device may be a oneway gate allowing animals to pass in only one direction. The second access device may also be an intelligent access device which may comprise identification means as will be described below.

A milking arrangement according to the present invention may comprise a separation area, wherein the second access device is arranged to allow an animal to pass from the milking area to one of at least the separation area and the resting area. This is preferably an intelligent access device, wherein the direction in which the animal is allowed to pass is dependent on the situation. Animals that are sick in some way may, with this arrangement, be directed into the separation area after having been in the milking area. This makes it possible to lead animals into the separation area because of diseases that are found in one of the milking stations during milking.

The milking arrangement may comprise a second animal identification means identifying an animal attending the second access device, and second control means being provided for the control of the second access device dependent on the identity of the animal. With an animal identification means it becomes possible to make the selection of animals automatic.

The milking arrangement may comprise a separation area, wherein the first access device is arranged to allow an animal to pass from the feeding area to one of at least the milking area, the resting area and the separation area. By having a milking arrangement with a separation area and having the second access device arranged to allow an animal to pass from the milking area to the separation area it is possible to choose animals to pass to the separation area before they have been milked. The access device may be automatically or manually controlled.

The milking area may comprise a waiting area, into which waiting area animals that are to be milked has to enter before they may enter the milking area. By including such a waiting area in the milking area it is possible to avoid animal congestion in front of the first access device, which may be the case when a lot of animals go to the first access device at a rate that is higher than the milking rate in the milking stations. Animals that are to be milked may enter the waiting area without any waiting time. This allows animals that not are to be milked to enter the resting area essentially without any waiting time.

The milking station may comprise at least one feeding device in the feeding area, wherein the feeding device is arranged to distribute food to the animals.

Each feeding device may comprise an animal identification means identifying an animal attending the feeding device and feeding control means for the control of the feeding device dependent on the identity of the animal. By having the feeding device distributing food dependent on the identity of the animal it becomes easier to control the feeding of the animals so that they all receive an optimum amount of food.

The feeding control device may be arranged to control the speed with which food is distributed dependent on the identity of the animal.

The feeding control device may be arranged to control the amount of food that is distributed dependent on the identity of the animal. This may be combined with controlling the speed with which food is distributed to the animals.

The feeding area may be arranged for providing food in the form of a total mixed ration to the animals, which is a mixture of all necessary food for the animals. By providing such total mixed rations to the animals they will get a proper mix of food. Food will thus essentially be provided to the animals in the feeding area.

According to the broadest aspect of the invention roughage may be provided separately from concentrated food in the feeding area. However, according to the preferred embodiment of the present invention the food is provided in the form of a total mixed ration.

According to a second aspect of the present invention a method for managing animals in a milking arrangement for automatic milking is provided. The method comprises the steps of providing food to the animals in a feeding area, allowing the animals to rest in a resting area, and milking the animals in a milking area with at least one milking station provided with means for attachment of teat cups, milking and detachment of the teat cups. The method is characterized in that it comprises the steps of allowing the animals to walk through a oneway gate between the resting area and the feeding area only in the direction from the resting area to the feeding area, and allowing the animals to walk through a first access device between the feeding area and the milking area only in the direction from the feeding area to the milking area.

By managing animals in a milking arrangement according to the method it has been found that the animals are milked frequently and voluntarily. Frequent milking is favorable both with respect to the milk production and the health of the animals udders. The milking area may be arranged in a number of different ways. The milking stations within the milking arrangement may be arranged in a so called rotary or in a stationary arrangement.

The method may also comprise the step of allowing an animal to pass from the feeding area to one of at least the milking area and the resting area. By allowing animals to pass directly from the feeding area and the resting area it is possible to avoid unneccessarily frequent milking.

The method may comprise the step of directing an animal that has entered the milking area to enter a milking station in which the animal is milked before the animal is allowed to leave the milking area. Alternatively the animals may be allowed to enter the milking stations voluntarily. By directing the animals into the milking station it is however possible to achieve a more efficient managing of the animals.

The method may comprise the step of allowing access between the milking area and the resting area only in the direction from the milking area to the resting area. By allowing the animals to pass only in said direction the managing also becomes more efficient. If animals are allowed to pass between the milking area and the resting area in both directions they may hinder each other and this may lead to congestions in the animal traffic within the milking arrangement.

The method may comprise the step of allowing an animal to pass from the milking area to one of at least a separation area and the resting area. By allowing an animal to pass from the milking area to the separation area it becomes possible to take animal under treatment directly after a disease has been discovered in the milking station.

The features described in relation to the milking arrangement above may where applicable also be incorporated in the method for arranging such an arrangement, with the same advantages as described above.

In the following preferred embodiments of the invention will be described with reference to the appended drawings.

### SHORT DESCRIPTION OF THE DRAWINGS

FIG. 1 shows schematically a milking arrangement according to an embodiment of the present invention, showing the principles of the present invention.

FIG. 2 shows in more detail a milking arrangement according to an embodiment of the present invention.

### DESCRIPTION OF EMBODIMENTS OF THE INVENTION

In the following embodiments of the invention will be described with reference to the appended drawings, in which similar features are denoted with the same reference numeral.

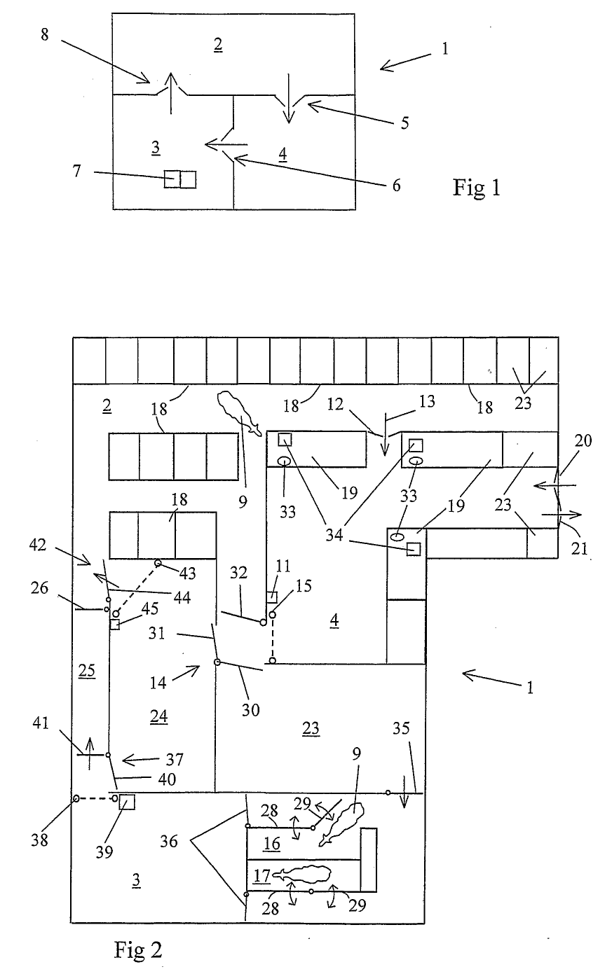

FIG. 1 shows schematically a milking arrangement 1 according to an embodiment of the present invention, showing the principles of the present invention. The milking arrangement 1, comprises a resting area 2, a milking area 3 and a feeding area 4. The resting area 2 is arranged for allowing the animals to walk and rest, the milking area is arranged for milking the animals, and the feeding area 4 is arranged for supplying food to the animals. A oneway gate 5 is arranged between the resting area 2 and the feeding area 4 allowing access from the resting area to the feeding area. A first access device 6 is arranged between the feeding area 4 and the milking area 3 allowing access between the feeding area and the milking area only in the direction from the feeding area to the milking area. The milking area comprises at least one milking station 7 provided with means for automatic attachment of teat cups, milking and detachment of the teat cups. In the embodiment shown in FIG. 1 a second access device 8 is provided between the milking area 3 and the resting area 2, allowing access between the milking area 3 and the resting area 2 only in the direction from the milking area 3 to the resting area 2. Also shown in FIG. 1 are animals 9 of which one is residing within the resting area 2.

The operation of the milking arrangement 1 may be described starting with an animal in the resting area 2, which comprises cubicles/resting places for animals in the arrangement. When the animal in the resting area 2 desires to eat the animal may pass through the oneway gate 5 into the feeding area where the animal freely may eat and/or drink. After having finished eating and/or drinking the animal usually wants to lay down and ruminate. As there are no proper spaces for laying down in the feeding area 4, the animal desires to leave the feeding area. There is only one way out of the feeding area, namely the first access device 6 leading to the milking area. In the milking area 3 the animal may be selected for milking before it may leave the milking area 3 through the second access device 8, which in this embodiment is a oneway gate. By providing a milking arrangement 1 according to the described embodiment it is has been found that a high milk production is achieved.

FIG. 2 shows in more detail a milking arrangement 1 according to an alternative embodiment of the present invention. The milking arrangement comprises a resting area 2, a milking area 3, and a feeding area 4, which areas have the same function as described above in relation to FIG. 1. The resting area 2 is provided with cubicles/resting places 18 and water bowls 23. The milking area 3 is provided with a first milking station 16 and a second milking station 17. The feeding area 4 is provided with feeding devices 19 and water bowls 23. An exit door 21 and an entrance door 20 are provided for allowing animals to pass between the feeding area and pasture and grazing areas surrounding the milking arrangement 1. In this way such areas are integrated with the feeding area 4 during the outdoor season. A number of water bowls 23 may be provided in the feeding area 4 as well as in the resting area 2, only a few of which have been disclosed in each area 2, 4, not to burden the drawing. Each feeding device 19 comprises an animal identification means 33 and a feeding control means 34 for control of the feeding device 19 dependent on the identity of the animal 9. More specifically, the control means 34 controls the amount and/or the speed with which food is dispensed and/or the composition of the food in the feeding device 19. It is within the scope of the invention to provide a more simple feeding device 19. The feeding device 19 may according to another embodiment of the present invention be an ordinary feeding table on which food is arranged manually, by an operator of the arrangement 1, or automatically. In this embodiment it is not necessary to provide any identification means.

In all described embodiments the preferred food is a total mixed ration, which is a mixture of all food to be fed to the animals such as, e.g., roughage, concentrated food, minerals, etc.

For illustrative reasons the lay-out in FIG. 2 has not been drawn in scale, meaning that the number of cubicles/resting places 18 and the extent of the feeding devices 19 are less than in the actual installation, which is intended for 100 to 120 cows. This follows from the fact that two automatic milking stations 16, 17, are provided in the milking area 3, each servicing around 50 to 60 cows. The adaptation of this layout to said number of cows may easily be taken care of by increasing the size of the barn while maintaining the inventive ideas behind the methods for feeding and animal traffic control illustrated in the drawing. Consequently, if the milking arrangement is intended for 50-60 animals it is sufficient with one automatic milking station 16,17. The number of animals for which the arrangement 1 is intended is, however, not important for the present invention.

The milking arrangement 1 also comprises a waiting area 23 for animals that are to be milked. Animals may wait in the waiting area 23 when all milking stations 16, 17, are occupied by animals that are being milked. An access gate 35 is arranged between the waiting area 23 and the milking area 3 The milking arrangement also comprises a separation area 24 for animals that are to be treated for some kind of disease or that are to be separated for other reasons.

A oneway gate 12 is arranged between the resting area 2 and the feeding area 4 allowing animals to pass only in the direction from the resting area to the feeding area as indicated by the arrow 13. A first access device 14 is arranged between the feeding area 4 and the milking area 3. An animal identification means 15 is arranged so that animals 9 leaving the feeding area 4 must pass the animal identification means 15. The animal identification means 15 comprises an interrogation station for interrogating a transponder carried by each animal 9. Primarily the transponder holds identity data of the animal, but it may store as well other data about the animal, e.g. an individual concentrate feeding program and data concerning the health status of the animal 9. In this case, however, such other data is stored in a computer, providing said data when triggered by the animal identity data and using said data for the control of feeding stations and gates, granting of milking permission, etc. The animal identification means 15 is connected to a first control means 11 controlling the first access device 14. The first access device comprises a first gate 30 leading to the waiting area 23, a second gate 31 leading to the separation area 24 and a third gate 32 leading to the resting area 2. The gates 30, 31, 32, of the first access device 14 are controlled by the first control means 11. A waiting oneway gate 35 is provided between the waiting area 23 and the milking area 3.

The milking area 3 comprises a first automatic milking station 16, and a second automatic milking station 17 including means for attachment of teat cups to the teats of the cow, milking the cow and detachment of the teat cups after milking has ended. Preferably, each of said stations is implemented by a DeLaval Voluntary Milking System VMS, including all means necessary for identification of the cow, milking, measurement of milk yield and quality, calculating health status data of the cow and providing an individual amount and composition of concentrate during milking.

Each milking station 16 and 17 is provided with an entrance gate 29 and an exit gate 28. The drawing shows that an animal 9 is being milked in the second milking station 17, of which the entrance gate 29 and the exit gate 28 are both closed. Another animal 9 is entering the first milking station 16 of which the entrance gate 29 is open and the exit gate 28 is closed. Swing gates 36 are provided after the exit gates 28 hindering animals from walking back into one of the milking stations 16, 17. The entrance gate 29 also functions as directing means directing an animal 9 in the milking area 3 into a milking station 16, 17.

A second access device 37 is provided between the milking area 3 and the resting area 2 allowing an animal 9 to pass from the milking area 3 to one of the separation area 24 and the resting area 2. A second animal identification means 38 is arranged so that animals 9 leaving the milking area 3 has to pass the second animal identification means 38. The second animal identification means 38 is of the same type as the first animal identification means 15. The second animal identification means 38 is connected to a second control means 39 controlling the second access device 37. The second access device comprises a first gate 40 leading to the separation area 24, and a second gate 41 leading to the resting area 2 through a passageway 25 and a passage oneway gate 26.

The first control means 11 and the second control means 39 do not have to be separate components but may be realised with a common standard computer which may also control the first milking station 16 and the second milking station 17 and which may also incorporate the feeding control means 34.

The milking arrangement 1 also comprises a third access device 42 with an animal identification means 43, a gate 44 and a control means 45 controlling the third access device 42. The third access device 42 allows an animal to pass from the separation area 24 to the resting area 2. The animal identification means of the third access device 42 has the same function as the animal identification means described above.

The operation of the milking arrangement 1 shown in FIG. 2 may be described starting with an animal 9 in one of the resting places 18. When the animal 9 is hungry the animal 9 may freely move into the feeding area 4 where the animal 9 may eat from the feeding devices 19 and/or drink from the water bowls 23. When the animal 9 attends one of the feeding devices 19 comprising an animal identification means, the animal identification means 33 will identify the animal and the control means 34 will control the feeding device 19 to distribute the correct amount of food to the animal.

After having finished eating the animal may leave the feeding area 4 by crossing the animal identification device 15 of the first access device 14. Depending on the identity of the animal one of the gates 30, 31, 32, of the first access device 14 is opened controlled by the first control means 11. In case the animal 9 is to be milked the first gate 30 is opened so that the animal may pass into the waiting area 23. In case the animal is to be separated the second gate 31 is opened so that the animal may pass into the separation area 24. In case the animal 9 has been milked recently the third gate 32 is opened allowing the animal 9 to pass into the resting area 2.

When one of the milking stations 16, 17 in the milking area 3 is idle the access gate 35 and the entrance gate 29 of the idle milking station is opened allowing an animal 9 in the waiting area 23 to enter the milking area 3 and the idle milking station. Concentrated food is provided within each one of the milking stations 16, 17, tempting the animal 9 to enter the milking station. After an animal has entered the milking station the entrance gate 29 is closed and milking of the animal 9 commences. After milking has finished the exit gate 28 of the milking station 16, 17, is opened and the animal may exit the milking station and go through one of the swing gates 36. The animal may then leave the milking area 3 by passing through the second access device 37. When an animal 9 attends the second animal identification means 38, one of the first gate 40 and the second gate 41 opens controlled by the second identification means dependent on the identity of the animal 9. In case the animal 9 is sick the first gate 40 is opened allowing the animal the to enter the separation area. In case the animal is allowed to go to the resting area 2 the second gate 41 is opened allowing the animal to pass through the passage 25 and the passage oneway gate 26 into the resting area.

In case an animal 9 has entered the separation area 24 the animal may leave the separation area through the third access device 42 by attending the animal identification means 43 of the third access device 42. In case the animal is allowed to leave the separation area the control device 45 of the third access device 42 opens the gate 44 of the third access device.

Information on whether an animal is sick or not may be gathered in any one of the milking stations 16, 17.

The above described embodiments of the present invention may be modified in a number of ways without departing from the spirit and scope of the present invention, which is only limited by the appended claims.

The arrangement shown in FIG. 2 comprises a separation area as well as a waiting area. It is, however, possible to dispense with either one of the separation area and the waiting area in a milking arrangement according to the present invention.

The exit door 21 may alternatively be arranged leading from the resting area 2. It is also possible to have an additional exit door arranged leading from the resting area 2 in addition to the exit door leading from the feeding area.

1. A milking arrangement for automatic milking of animals comprising:
a feeding area arranged for supplying food to the animals;
a resting area arranged for allowing the animals to rest;
a milking area with at least one milking station provided with means for attachment of teat cups for milking and detachment of the teat cups;
a oneway gate arranged between the resting area and the feeding area allowing access from the resting area to the feeding area; and
at least a first access device arranged between the feeding area and the milking area allowing access between the feeding area and the milking area only in the direction from the feeding area to the milking area.

2. The milking arrangement according to claim 1, wherein the first access device is arranged to allow an animal to pass from the feeding area to one of at least the milking area and the resting area.

3. The milking arrangement according to claim 2, comprising at least a first animal identification means being arranged to identify an animal attending the first access device, and first control means for the control of the first access device dependent on the identity of the animal and whether the animal is permitted to be milked or not.

4. The milking arrangement according to claim 1, wherein a second access device is provided between the milking area and the resting area, allowing access between the milking area and the resting area only in the direction from the milking area to the resting area.

5. The milking arrangement according to claim 4, further comprising a separation area, wherein the second access device is arranged to allow an animal to pass from the milking area to one of at least the separation area and the resting area.

6. The milking arrangement according to claim 5, comprising a second animal identification means for identifying an animal attending the second access device, and second control means being provided for the control of the second access device dependent on the identity of the animal.

7. The milking arrangement according to claim 1, further comprising a separation area, wherein the first access device is arranged to allow an animal to pass from the feeding area to one of at least the milking area, the resting area and the separation area.

8. The milking arrangement according to claim 5, wherein the first access device is arranged to allow an animal to pass from the feeding area to one of at least the milking area, the resting area and the separation area.

9. The milking arrangement according to claim 1, wherein the milking area comprises a waiting area located whereby animals that are to be milked have to enter the waiting area before they may enter the milking area.

10. The milking arrangement according to claim 1, further comprising at least one feeding device in the feeding area, wherein the feeding device is arranged to distribute food to the animals.

11. The milking arrangement according to claim 10, wherein each feeding device comprises an animal identification means identifying an animal attending the feeding device, and feeding control means for the control of the feeding device dependent on the identity of the animal.

12. The milking arrangement according to claim 11, wherein the feeding control means is arranged to control the speed with which food is distributed dependent on the identity of the animal.

13. The milking arrangement according to claim 11, wherein the feeding control means is arranged to control the amount of food that is distributed dependent on the identity of the animal.

14. The milking arrangement according to claim 1, wherein the feeding area is arranged for providing food in the form of a total mixed ration to the animals.

15. A method for managing animals in a milking arrangement for automatic milking, comprising the steps of providing food to the animals in a feeding area, allowing the animals to rest in a resting area, milking the animals in a milking area with at least one milking station provided with means for attachment of teat cups, milking and detachment of the teat cups, allowing the animals to walk through a oneway gate between the resting area to the feeding area only in the direction from the resting area to the feeding area, and allowing the animals to walk through a first access device between the feeding area and the milking area only in the direction from the feeding area to the milking area.

16. The method according to claim 15, further comprising the step of allowing an animal to pass through the first access device from the feeding area to one of at least the milking area and the resting area.

17. The method according to claim 15, further comprising the step of allowing access between the milking area and the resting area only in the direction from the milking area to the resting area.

18. The method according to claim 15, further comprising the step of allowing an animal to pass from the milking area to one of at least a separation area and the resting area.

19. The method according to claim 15, further comprising the step of providing food to the animals in the feeding area in the form of a total mixed ration.
